(19) United States
(12) Patent Application Publication
(10) Pub. No.: US 2023/0374195 A1
(43) Pub. Date: Nov. 23, 2023

(54) Value Chain Return Process for Spent Polyurethanes by Hydrogenation

(71) Applicant: BASF SE, Ludwigshafen (DE)

(72) Inventors: Thomas Schaub, Ludwigshafen (DE); Paul Neumann, Ludwigshafen (DE); Mona Al Batal, Ludwigshafen (DE); A. Stephen K. Hashmi, Heidelberg (DE); Wei Zhou, Heidelberg (DE); Andreas Thomas Haedler, Ludwigshafen (DE); Markus Schuette, Lemfoerde (DE); Viktoriia Zubar, Heidelberg (DE)

(21) Appl. No.: 18/031,396

(22) PCT Filed: Oct. 12, 2021
(86) PCT No.: PCT/EP2021/078127

§ 371 Date: Apr. 12, 2023

(30) Foreign Application Priority Data
Oct. 13, 2020 (EP) 20201520.2
Jun. 17, 2021 (EP) 21180038.8

(51) Int. Cl. C08G 18/82; C08J 11/28; B01J 31/18; B01J 31/20

(52) U.S. Cl. CPC C08G 18/82; C08J 11/28; B01J 31/189; B01J 31/20; C08J 2375/04; B01J 2531/821; B01J 2231/641

(57) ABSTRACT

Spent polyurethanes are returned to the value chain by hydrogenating the spent polyurethanes in a hydrogen atmosphere in the presence of at least one homogeneous transition metal catalyst complex, wherein the transition metal is selected from metals of groups 7, 8, 9 and 10 of the periodic table of elements according to IUPAC, to obtain a polyamine and a polyol. The hydrogenation is carried out at a reaction temperature of at least 120° C. in a non-reducible solvent having a dipole moment of 10-10³⁰ C·m or less.

The present invention relates to a value chain return process for spent polyurethanes, comprising their hydrogenating to obtain polyamines and polyols. The process is carried out in the presence of a homogeneous transition metal catalyst complex in selected solvents.

In the last three decades, there has been an enormous increase in worldwide plastics demand. For example, in the last 10 years, the amount of plastics produced worldwide has increased by almost 50%. Within 30 years, it has even almost quadrupled reaching an amount of 359 million metric tons in 2018. From these facts, it becomes clear that production of said huge amounts of plastics is followed by a need to dispose or recycle spent plastics. Preference should be given to recycling as thereby valuable materials, e.g. compounds which can act as monomers, can be added back to the value chain, e.g. by direct re-use in plastics production.

Thus, there is a need to develop processing techniques to recover materials from used plastics. The recycling process of spent plastics should reduce both the waste of material and the carbon footprint. Further, it should be an economical and energy efficient process delivering valuable materials which comprise high technical features.

In contrast, disposal, e.g. by combustion, has a negative impact on the environment as well as on the carbon footprint.

Among the plastics mentioned above, e.g. polyurethanes (PU) are important representatives. Polyurethanes are e.g. used in applications such as foams, elastomers, lenses, packaging, insulation, footwear, textiles, synthetic leather, coatings, paints or sealings.

The recycling of industrially important aromatic-based polyurethanes, e.g. toluenediisocyanate-based polyurethanes, to valuable monomeric compounds still remains challenging. So far, only the polyol compound can be recovered and recycled by glycolysis or hydrolysis (see: Plastics recycling and Polyurethanes, in Ullmann's Encyclopedia of Industrial Chemistry, 2020, DOI: 10.1002/14356007.a21_057.pub2). However, the valuable aromatic building block has not yet been recycled in sufficient yields. Therefore, it would be of high economic interest to depolymerize toluenediisocyanate-based polyurethanes by hydrogenation in a way that the polyol as well as the aromatic compound can be obtained.

A. Kumar et al., J. Am. Chem. Soc. 2020, 142, 14267-14275 describe the hydrogenative depolymerization of nylons and polyurethanes. The diisocyanate building block is obtained in the form of the diamine, which can easily be used to produce new diisocyanate. The carbonyl-group will be hydrogenated to methanol. The authors describe hydrogenation of diisocyanate-based polyurethanes in the presence of a homogeneous ruthenium-based catalyst with tridentate P,N,N-ligands. So far, good results were obtained at 150° C. in DMSO as a solvent. Indeed, it is claimed that DMSO as a solvent plays a critical role. It is stated that, on the other hand, “no conversion of nylon 6 was observed when toluene, tetrahydrofuran, 1,4-dioxane, water or dimethylformamide was used” (page 14268, right column).

T. Schaub et al., ChemSusChem, 2020, DOI: 10.1002/cssc.202002465 describe the depolymerization of nylons and polyurethanes using homogeneous ruthenium catalyst with tridentate P,N,N-ligands in tetrahydrofuran as solvent. So far, good results were obtained using the ruthenium catalysts at 200° C., 100 bar H₂ in tetrahydrofuran as solvent. A drawback of this system is the use of expensive and rare ruthenium as the active catalyst metal. For an economic technical process, the use of less expensive and abundant metals as active catalysts material would be desirable.

T. Skrydstrup et al., JACS Au, 2021, DOI: 10.1021/jacsau.1c00050 describe the depolymerization of polyurethanes using 2 mol-% of a homogeneous manganese catalyst with tridentate P,N,P-ligands in tetrahydrofuran as solvent at 150° C. and bar H₂ pressure. But, under this conditions, only low conversions of the polymeric material of 25% can be achieved, which is not sufficient for an potential use in a process. Therefore, a system is required, delivering higher conversions of the polyurethane material using manganese catalyst.

However, said plastics recycling process has major drawbacks such as low catalyst turnover-activity or the use of expensive precious metal catalysts. Further, when extending the substrate scope to plastics having aromatic functionalities, the conditions described above may lend themselves to undesired side reactions such as core hydrogenation. Also, the use of the polar, unsaturated solvent DMSO is a drawback, as under the hydrogenation conditions dimethylsulfide can be formed as a side product by hydrogenation of DMSO. Further, separation of DMSO from the products is difficult due to its high boiling point and DMSO is prone to decomposition at the elevated reaction temperatures (see: Org. Process Res. Dev. 2020, 24, 1614-1620).

Therefore, it is the object of the present invention to provide an environmentally friendly and economically advantageous catalytic hydrogenation reaction for hydrogenating spent polyurethanes to obtain polyamines and polyols.

This object has been achieved by a value chain return process for spent polyurethanes. The process comprises hydrogenating the spent polyurethanes in a hydrogen atmosphere in the presence of at least one homogeneous transition metal catalyst complex, wherein the transition metal is selected from metals of groups 7, 8, 9 and 10 of the periodic table of elements according to IUPAC, to obtain a polyamine and a polyol, characterized in that the hydrogenation reaction is carried out at a reaction temperature of at least 120° C. in a non-reducible solvent having a dipole moment of 10·10⁻³⁰ C·m or less.

“Value chain return” is intended to mean that the low molecular products obtained by the process of the invention can be re-integrated in a value chain leading to polyurethanes or else be used as feedstocks in an other value chain.

A solvent suitable for the hydrogenation of polyurethanes must have certain properties, including the ability to dissolve the polyurethanes used as starting materials, chemical inertness under the hydrogenation conditions, and electronic properties allowing hydrogenation of the polyurethanes.

According to the invention, the hydrogenation is carried out in a non-reducible solvent having a dipole moment of 10·10⁻³⁰ C·m or less, for example in the range of 1·10⁻³⁰ to 10·10⁻³⁰ C·m.

The term “non-reducible” means that the solvent is not capable of reacting with hydrogen at the reaction conditions applied, e.g. at the temperature and pressure at which the process is operated. That is, non-reducible solvents do not contain C═O, C═S, CEN or non-aromatic C═C bonds.

The solvent has a dipole moment of 10·10⁻³⁰ C·m or less, for example in the range of 1·10⁻³⁰ to 10·10⁻³⁰ C·m, measured at a temperature 298 K. For example, the solvent has a dipole moment in the range of 1.5·10⁻³⁰ to 8·10⁻³⁰ C·m, more preferred in the range of 2·10⁻³⁰ to 6·10⁻³⁰ C·m. The dipole moment of a solvent is a relative measure of its chemical polarity. High dipole moment values correlate to polar solvents. Reference values for dipole moment of commonly used solvents may be obtained, e.g., from Handbook of Chemistry and Physics, CRC Press, Boca Raton, Florida, 91st Edition, 2010.

It is contemplated that the solubility of polyurethanes is higher in more polar solvents. However, highly polar solvents have drawbacks as discussed above.

Therefore, the present selection of solvents having zero to medium polarity, i.e. dipole moment values of 10·10⁻³⁰ C·m or less, is a trade-off between a suitable polarity, which dissolve the polyurethanes at least to the extent that they are accessible for hydrogenation, while avoiding the drawbacks of highly polar solvents.

In a preferred embodiment, the non-reducible solvent comprises at least one electron pair donor. The “electron pair donor” provides nucleophilicity to the solvent and thereby facilitates activation of the bonds to be hydrogenated. The solvent comprises functional groups that act as electron pair donor. Suitable electron pair donors include atoms such as nitrogen or oxygen, e.g., bound as amino group, hydroxyl group or ether moieties. Generally, non-protic solvents are preferred.

In one embodiment, the non-reducible solvent is selected from ethers, alcohols and amines.

Suitable ethers (dipole moment values in brackets) are selected from tetrahydrofuran (5.84·10⁻³⁰ C·m), 1,4-dioxane (1.50·10⁻³⁰ C·m), anisole (4.17·10⁻³⁰ C·m), diethyl ether (4.34·10⁻³⁰ C·m), diisopropyl ether (4.34·10⁻³⁰ C·m), dibutyl ether (3.90·10⁻³⁰ C·m), methyl tert-butyl ether (4.40·10⁻³⁰ C·m), and diethylene glycol dimethyl ether (5.70·10⁻³⁰ Cm).

Suitable alcohols are selected from methanol (5.61·10⁻³⁰ C·m), ethanol (5.7·10⁻³⁰ Cm), n-propanol (5.54·10⁻³⁰ C·m), isopropanol (5.54·10⁻³⁰ C·m), tert-butanol (5.54·10⁻³⁰ Cm), trifluorethanol (6.77·10⁻³⁰ C·m), ethyleneglycol (7.61·10⁻³⁰ C·m), and 1,3-propandiol (8.41·10⁻³⁰ C·m).

Suitable amines are selected from 1-butylamine (3.34·10⁻³⁰ C·m), triethylamine (2.90·10⁻³⁰ C·m), ethylenediamine (6.64·10⁻³⁰ C·m), morpholine (4.94·10⁻³⁰ C·m), piperidine (3.9·10⁻³⁰ C·m), and aniline (5.04·10⁻³⁰ C·m).

If desired, mixtures of two or more of the afore-mentioned solvents may be used.

In a preferred embodiment, the non-reducible solvent is selected from tetrahydrofuran, 1,4-dioxane or anisole. Tetrahydrofuran is particularly preferred.

In one embodiment, the non-reducible solvent is selected from aromatic solvents, in particular from aromatic hydrocarbons.

The aromatic solvent is defined as an aromatic compound with at least one aromatic ring, which is not being hydrogenated under the conditions of the polyurethane hydrogenation and is liquid at a temperature of above 70° C.

Suitable aromatic solvents (dipole moment values in brackets) are selected from benzene (0·10⁻³⁰ C·m), toluene (1.20·10⁻³⁰ C·m), ortho-xylene (2·10·10⁻³⁰ C·m), meta-xylene (1.1·10⁻³⁰ C·m), para-xylene (0·10⁻³⁰ C·m), ethylbenzene (1.93·10⁻³⁰ C·m), mesitylene (0.16·10⁻³⁰ C·m), anisole (4.17·10⁻³⁰ C·m), pyridine (7.34·10⁻³⁰ C·m), 2,3-lutidine (7.34·10⁻³⁰ C·m), 2,4-lutidine (7.67·10⁻³⁰ C·m), 2,5-lutidine (7.17·10⁻³⁰ C·m), 2,6-lutidine (5.50·10⁻³⁰ C·m), 3,4-lutidine (6.24·10⁻³⁰ C·m), 3,5-lutidine (8.61·10⁻³⁰ C·m), collidine (6.44·10⁻³⁰ C·m), 2-picoline (6.54·10⁻³⁰ C·m), 3-picoline (8.04·10⁻³⁰ C·m), 4-picoline (8.57·10⁻³⁰ C·m), aniline (5.04·10⁻³⁰ C·m), N,N-dimethylaniline (5.37·10⁻³⁰ C·m) and diphenylether (3.90·10⁻³⁰ C·m).

In a preferred embodiment, the aromatic solvent is selected from benzene, toluene, xylene, mesitylene, and anisole.

If desired, mixtures of two or more aromatic solvents may be used. Additionally, mixtures of one or more aromatic solvents with a non-reducible, non-aromatic solvent, such as those disclosed above, may be used. Such mixture may, for example, be a mixture of toluene and tetrahydrofuran.

The amount of the aromatic solvent is in the range of 10 to 100 wt-%, preferably 30 to 100 wt-%, more preferable 50 to 100 wt-%, relative to the total amount of the solvents.

In one embodiment, the hydrogenation reaction is carried out in the essential absence of DMSO. More preferably, the hydrogenation reaction is carried out in the absence of a solvent other than solvents defined above, i.e. in the absence of solvents that are reducible under the conditions of the process and/or having a dipole moment of more than 10·10⁻³⁰ C·m.

While the net energy balance of the hydrogenation reaction is exothermal, the initiation requires supply of energy (activation energy). Higher temperatures also facilitate solubilization of the polyurethane by the solvents defined above to make the polyurethane accessible for hydrogenation. To provide the required activation energy and to solubilize sufficient amounts of polyurethane, the hydrogenation reaction is carried out at elevated reaction temperatures of at least 120° C. In one embodiment, the reaction temperature is from 150 to 220° C., preferably from 180 to 210° C.

The hydrogenation is carried out in a hydrogen atmosphere. This is because molecular hydrogen is consumed during the hydrogenation reaction of polyurethanes. Hydrogen pressure has an influence on the outcome of the reaction. Lower pressures typically result in a slower rate of reaction, whereas higher pressures result in a faster rate of reaction. Thus, the hydrogen atmosphere is suitably present at elevated pressure levels. Hence, the hydrogenation reaction occurs in a pressurized reaction vessel, e.g. an autoclave. In one embodiment, the hydrogenation reaction is carried out at a pressure of 30 to 500 bar absolute, preferably 50 to 300 bar absolute, more preferably 80 to 200 bar absolute.

The hydrogenation reaction is carried out in the presence of at least one homogeneous transition metal catalyst complex (hereinafter also referred to as “hydrogenation catalyst”), comprising at least one polydentate ligand having at least one nitrogen atom and at least one phosphorous atom which are capable of coordinating to the transition metal.

Generally, the amount of the hydrogenation catalyst present in the hydrogenation reaction may be varied in a wide range. Suitably, the hydrogenation catalyst is present in the hydrogenation reaction in an amount of 0.1 to 5000 ppm (parts per weight calculated as catalyst metal), preferably 1 to 2000 ppm, more preferably 50 to 1000 ppm.

The hydrogenation catalyst comprises a transition metal selected from metals of groups 7, 8, 9 and 10, preferably of groups 7 or 8, of the periodic table of elements according to IUPAC.

In one embodiment, the homogeneous transition metal catalyst complex comprises a transition metal selected from manganese, iron, cobalt, rhodium, osmium, rhenium, ruthenium, iridium, nickel, palladium and platinum. A preferred transition metal is ruthenium. A further preferred transition metal is manganese due to its wide availability.

One embodiment of the present invention relates to a process wherein the transition metal is manganese and the non-reducible solvent is selected from ethers, alcohols, and aromatic solvents, preferably aromatic solvents, in particular toluene.

Generally, the homogeneous transition metal catalyst complex comprises at least one ligand in order to solubilize the transition metal in the reaction solution and to maintain the transition metal in an active form for hydrogenation. Preferred ligands are polydentate ligands having at least one nitrogen atom and at least one phosphorous atom which are capable of coordinating to the transition metal.

The hydrogenation catalyst may further comprise one or more additional ligands, such as an anion selected from the group consisting of hydride, alkoxides, aryloxides, carboxylates and acyl, or a neutral ligand selected from the group consisting of carbon monoxide, triaryl phosphines, amines, N-heterocyclic carbenes and isonitriles.

Preferably, the hydrogenation catalyst further comprises a carbon monoxide ligand, a halide or a hydride.

In one embodiment, the at least one polydentate ligand conforms to general formula (I)

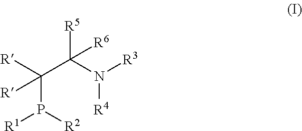

in which
each R′ is independently H or C₁-C₄-alkyl,
R¹ and R², independently of one another, are C₁-C₁₂-alkyl, cycloalkyl or aryl, which alkyl is unsubstituted or carries 1, 2, 3, 4 or 5 identical or different substituents R⁷, and
   which cycloalkyl and aryl are unsubstituted or carry 1, 2, 3, 4 or 5 identical or different substituents R⁸,
R³ and R⁴, independently of one another, are H or C₁-C₁₂-alkyl, which is unsubstituted or carries 1, 2, 3, 4 or 5 identical or different substituents selected from heterocycloalkyl, aryl, hetaryl, alkoxy, cycloalkoxy, heterocycloalkoxy, aryloxy, hetaryloxy, hydroxyl, NE¹E² and PR¹R²,
R⁵ is H or C₁-C₁₂-alkyl, which is unsubstituted or carries 1, 2, 3, 4 or 5 identical or different substituents R⁷,
R⁶ is H or C₁-C₄-alkyl,
or
R⁴ and R⁶ are absent and R³ and R⁵, together with the nitrogen atom to which R³ is bonded and the carbon atom to which R⁵ is bonded, form a 6-membered heteroaromatic ring,
   which is unsubstituted or carries 1, 2, 3, 4 or 5 identical or different substituents which are selected from C₁-C₁₂-alkyl, cycloalkyl, aryl and hetaryl, which alkyl is unsubstituted or carries 1, 2, 3, 4 or 5 identical or different substituents R⁷, and
   which cycloalkyl, aryl and hetaryl are unsubstituted or carry an alkyl substituent which is unsubstituted or carries a substituent selected from alkoxy, cycloalkoxy, heterocycloalkoxy, aryloxy, hetaryloxy, hydroxyl, NE¹E² and PR¹R²,
each R⁷ is independently cycloalkyl, heterocycloalkyl, aryl, hetaryl, alkoxy, cycloalkoxy, heterocycloalkoxy, aryloxy, hetaryloxy, hydroxyl or NE¹E²,
each R⁸ is independently C₁-C₄-alkyl, cycloalkyl, heterocycloalkyl, aryl, hetaryl, alkoxy, cycloalkoxy, heterocycloalkoxy, aryloxy, hetaryloxy, hydroxyl or NE¹E², and
E¹ and E², independently of one another and independently of each occurrence, are radicals selected from H, C₁-C₁₂-alkyl, cycloalkyl and aryl.

The term “cycloalkyl” (also in combinations such as “cycloalkyloxy”) indicates a saturated cyclic aliphatic hydrocarbon radical having 3 to 8 carbon atoms, preferably 4 to 7 carbon atoms, more preferably 5 to 6 carbon atoms. Preference is given to cyclo-pentyl or cyclohexyl.

The term “heterocycloalkyl” (also in combinations such as “heterocycloalkoxy”) indicates a saturated 3 to 8 membered cyclic hydrocarbon radical, wherein one or more carbon atoms have been replaced by heteroatoms selected from O, S, N and P, or combinations thereof. Preference is given to pyrrolidinyl, imidazolidinyl, pyrazolidinyl, piperidyl, piperazinyl, morpholinyl, tetrahydrofuranyl, tetrahydropyranyl, tetrahydrothiophene and the like, and also methyl-, ethyl-, propyl-, isopropyl- and tea-butyl-substituted derivatives thereof.

The term “aryl” (also in combinations such as aryloxy) indicates monocyclic or annelated aromatic carbocycles, preferably phenyl or naphthyl radicals, more preferably phenyl radicals.

The term “hetaryl” (also in combinations such as hetaryloxy) indicates a 3 to 8 membered aromatic carbocycle, wherein one or more carbon atoms have been replaced by heteroatoms selected from O, S, N and P, or combinations thereof, and which may be annelated with 1 or 2 aromatic cycles. Preference is given to furyl, thienyl, pyrrolyl, pyridyl, pyrazolyl, imidazolyl, oxazolyl, thiazolyl, pyrimidinyl, pyrazinyl and the like, and also methyl-, ethyl-, propyl-, isopropyl- and tert-butyl-substituted derivatives thereof. Most preferably, hetaryl is pyridyl.

Preferably, R′ is H.

Preferably, R¹ and R² are identical and are selected from the group consisting of isopropyl, cyclohexyl, tert-butyl, and phenyl.

Preferably, R³ is H or C₁-C₃-alkyl.

Preferably, R⁴ is H; or —(CH₂)₂—PR¹R², e.g., —(CH₂)₂—PPh₂ or —(CH₂)₂—PⁱPr₂; or Cl-alkyl which carries 1 hetaryl substituent, e.g., —(CH₂)—(2-pyridyl) or —(CH₂)—(1-methyl-imidazol-2-yl).

Preferably, R⁵ is H or C₁-C₃-alkyl.

Preferably, R⁶ is H.

In a further preferred embodiment, R⁶ and R⁴ are absent and R³ and R⁵, together with the nitrogen atom to which R³ is bonded and the carbon atom to which R⁵ is bonded, form a 6-membered heteroaromatic ring. Preferably, the 6-membered heteroaromatic ring carries one substituent, preferably in the 6-position, assuming that the heteroatom is in the 1-position and —CR′R′—PR¹R² is in the 2-position.

In one embodiment, the at least one polydentate ligand conforms to general formula (II)

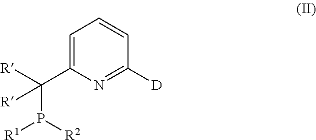

in which
D is H, C₁-C₁₂-alkyl, cycloalkyl, aryl or hetaryl,
which alkyl is unsubstituted or carries 1, 2, 3, 4 or 5 identical or different substituents R⁷, and
which cycloalkyl, aryl or hetaryl are unsubstituted or carry an alkyl substituent which is unsubstituted or carries a substituent selected from alkoxy, cycloalkoxy, heterocycloalkoxy, aryloxy, hetaryloxy, hydroxyl, NE¹E² and PR¹R², preferably NE¹E² and PR¹R².

In a preferred embodiment, D is C₁-C₁₂-alkyl substituted by NE¹E²; hetaryl which is unsubstituted; or hetaryl which carries a C₁-C₁₂-alkyl substituted by NE¹E² or PR¹R².

In a more preferred embodiment, D is a methyl group substituted by NE¹E²; 2-pyridyl which is unsubstituted; or 2-pyridyl which is substituted in 6-position by —CH₂—NE¹E² or —CH₂—PR¹R².

In one embodiment, the at least one polydentate ligand is selected from compounds A to L,
wherein Et is ethyl, ⁱPr is isopropyl, Bu is tert-butyl, Cy is cyclohexyl, Ph is phenyl:

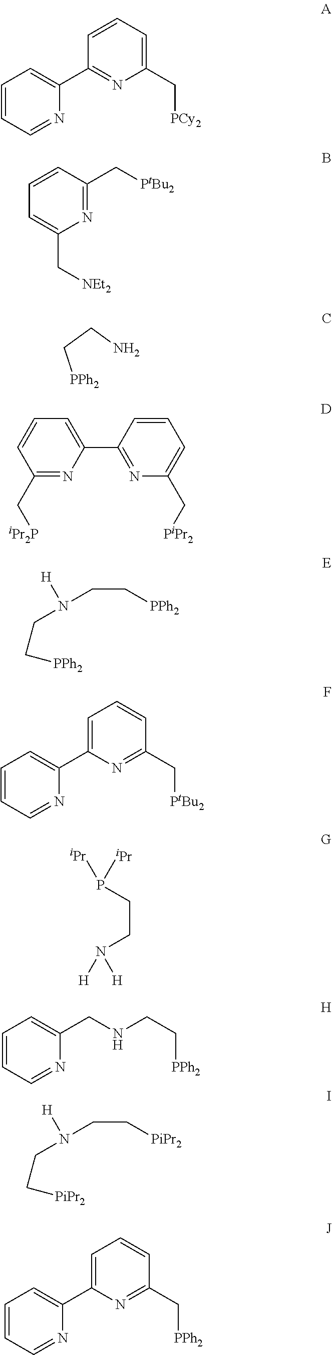

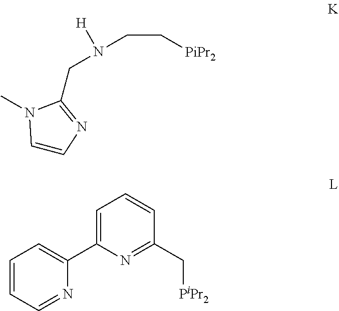

Homogeneous, e.g. ruthenium-based, hydrogenation catalyst complexes have been known per se. Such catalyst complexes allow for catalytically active ruthenium in an effective environment for hydrogenations. For this purpose, various ligand systems have been studied; for example, BINAP- (Noyori), P,N,N- (Milstein) or P,N,P-ligands (Takasago) have been used successfully in hydrogenation reactions.

Similarly, manganese-based hydrogenation catalyst complexes have been known per se.

In a preferred embodiment, the transition metal is ruthenium and the polydentate ligand conforms to one of compounds A to G or J.

In another embodiment, the transition metal is manganese and the polydentate ligand conforms to one of compounds A, E, or H to L.

The hydrogenation catalyst may be employed in the form of a preformed metal complex, which comprises the metal compound and one or more ligands.

In a preferred embodiment, the hydrogenation catalyst is a pre-formed ruthenium-catalyst, selected from compounds Ru-1 to Ru-10,
wherein Et is ethyl, ⁱPr is isopropyl, Bu is tert-butyl, Cy is cyclohexyl, Ph is phenyl:

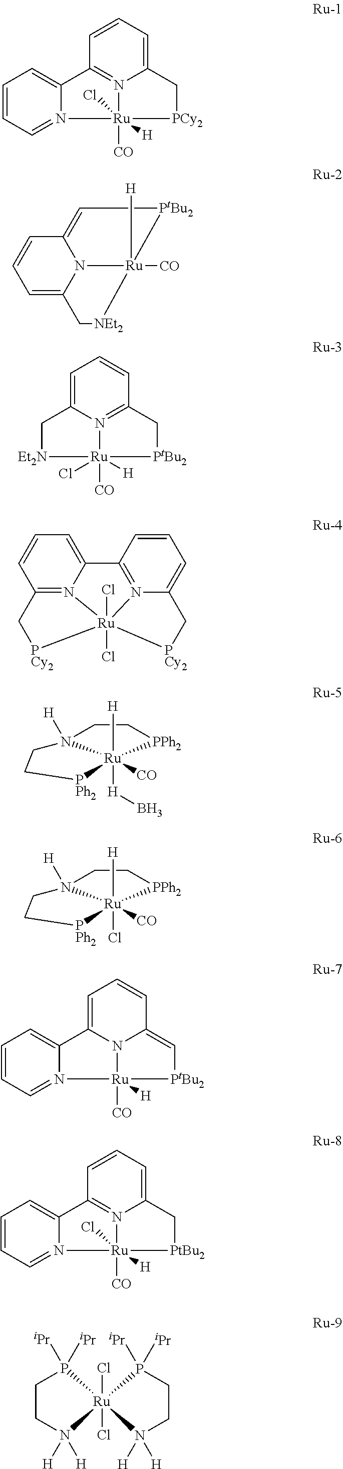

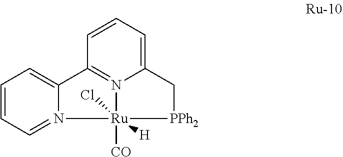

or the hydrogenation catalyst is a pre-formed manganese-catalyst, selected from compounds Mn-1 to Mn-8,
wherein ⁱPr is isopropyl, Cy is cyclohexyl, Ph is phenyl:

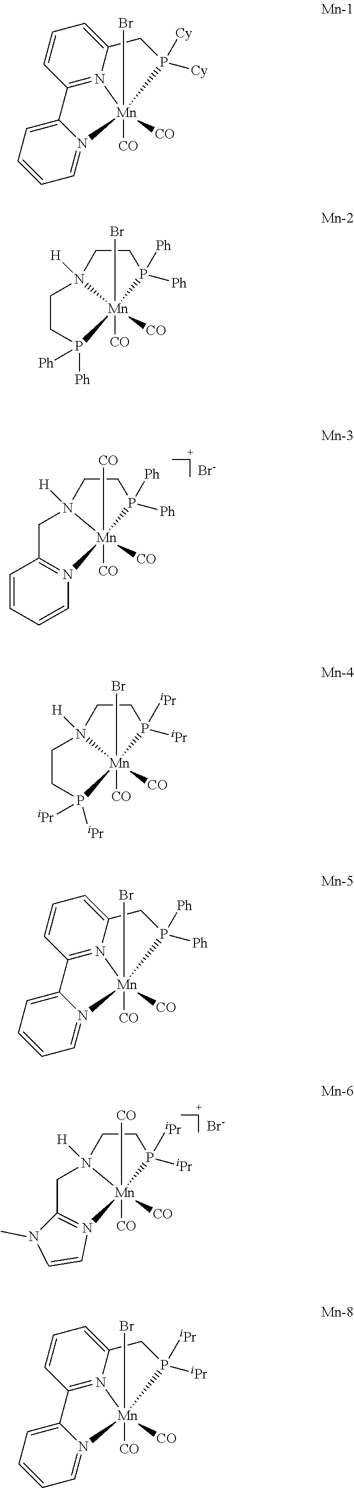

No special or unusual techniques are needed for preparing the catalyst used in the present invention. However, in order to obtain a catalyst of high activity, it is preferred to carry out the manipulations under an inert atmosphere, e.g., nitrogen, argon and the like.

Alternatively, the hydrogenation catalyst is formed in situ in the reaction mixture by combining a metal compound, hereinafter also referred to as “pre-catalyst”, and at least one suitable ligand to form a catalytically active metal complex in the reaction medium (“hydrogenation catalyst”). It is also possible that the hydrogenation catalyst is formed in situ in the presence of an auxiliary ligand by combining a metal compound and at least one auxiliary ligand to form a catalytically active metal complex in the reaction medium.

Suitable pre-catalysts are selected from neutral metal complexes, oxides and salts of the transition metals. Preferred pre-catalysts are selected from metal complexes, oxides and salts of manganese, rhenium, ruthenium, iridium, nickel, palladium and platinum.

In the context of this application, “COD” denotes 1,5-cyclooctadiene, “Cp” denotes cyclopentadienyl, “Cp*” denotes pentamethylcycopentadienyl and “binap” denotes 2,2′-bis(diphenylphosphino)-1,1′-binaphthyl.

Suitable rhenium pre-catalysts are selected from ammoniumperrhenate, chlorotricarbonyl(2,2′-bipyridine)rhenium(I), chlorotricarbonyl(4,4′-di-t-butyl-2,2′-bi-pyridine)rhenium(I), cyclopentadienylrhenium tricarbonyl, iododioxobis(triphenyl-phosphine)rhenium(V), methyltrioxorhenium(VII), pentamethylcyclopentadienylrhenium tricarbonyl, rhenium carbonyl, rhenium(V) chloride, rhenium pentacarbonyl bromide, and trifluoromethylsulfonatotricarbonyl(2,2′-bipyridine)rhenium(I).

Suitable ruthenium pre-catalysts are selected from [Ru(methylallyl)₂COD], [Ru(p-cymene)Cl₂]₂, [Ru(benzene)C₁₋₂]ₙ, [Ru(CO)₂Cl₂]ₙ, [Ru(CO)₃Cl₂]₂, [Ru(COD)(allyl)], [RuCl₃·H₂O], [Ru(acetylacetonate)₃], [Ru(DMSO)₄Cl₂], [Ru(PPh₃)₃(CO)(H)Cl], [Ru(PPh₃)₃(CO)Cl₂], [Ru(PPh₃)₃(CO)(H)₂], [Ru(PPh₃)₃Cl₂], [Ru(Cp)(PPh₃)₂Cl], [Ru(Cp)(CO)₂Cl], [Ru(Cp)(CO)₂H], [Ru(Cp)(CO)₂]₂, [Ru(Cp*)(CO)₂Cl], [Ru(Cp*)(CO)₂H], [Ru(Cp*)(CO)₂]₂, [Ru(indenyl)(CO)₂Cl], [Ru(indenyl)(CO)₂H], [Ru(indenyl)(CO)₂]₂, ruthenocen, [Ru(binap)(Cl)₂], [Ru(2,2′-bipyridin)₂(Cl)₂·H₂O], [Ru(COD)(Cl)₂H]₂, [Ru(Cp*)(COD)Cl], [Ru₃(CO)₁₂], [Ru(tetraphenylhydroxycyclopentadienyl)(CO)₂H], [Ru(PMe₃)₄(H)₂], [Ru(PEt₃)₄(H)₂], [Ru(Pn-Pr₃)₄(H)₂], [Ru(Pn-Bu₃)₄(H)₂], and [Ru(Pn-octyl₃)₄(H)₂], preferably [Ru(methylallyl)₂COD], Ru(COD)Cl₂]₂, [Ru(Pn-Bu₃)₄(H)₂], [Ru(Pn-octyl₃)₄(H)₂], [Ru(PPh₃)₃(CO)(H)Cl] and [Ru(PPh₃)₃(CO)(H)₂], more preferably [Ru(PPh₃)₃(CO)(H)Cl].

Suitable iridium pre-catalysts are selected from [IrCl₃·H₂O], KIrCl₄, K₃IrCl₆, [Ir(COD)Cl]₂, [Ir(cyclooctene)₂Cl]₂, [Ir(ethene)₂Cl]₂, [Ir(Cp)Cl₂]₂, [Ir(Cp*)Cl₂]₂, [Ir(Cp)(CO)₂], [Ir(Cp*)(CO)₂], [Ir(PPh₃)₂(CO)Cl], and [Ir(PPh₃)₃Cl], preferably [Ir(COD)Cl]₂, [Ir(cyclo-octene)₂Cl]₂, and [Ir(Cp*)Cl₂]₂.

Suitable nickel pre-catalysts are selected from [Ni(COD)₂], Ni(CO)₄, NiCl₂, NiBr₂, Nile, Ni(OAc)₂ [Ni(AcAc)₂], [Ni(Cl)₂(TMEDA)], [Ni(Cl)₂(DME)], [Ni(Br)₂(DME)], [Ni(Cl)₂(PPh₃)₂], [Ni(CO)₂(PPh₃)], [Ni(Cl)(methallyl)]₂, [Ni(CO₃)], nickel(II)diemthylglyoxime, nickel(II)₂-ethylhexanoate, nickel(II)hexafluroacetlyacetonate, bis(N,N′-di-t-butylacetamidinato)nickel(II), nickel(II)oxalate, Ni(NO₃)₂, nickel(II)stearate, Ni(SO₄), nickel(II)tetrafluoroborate hexahydrate, nickel(II)trifluoroaceylacetonate dehydrate, and nickel(II)trifluoromethanesulfonate.

Suitable palladium pre-catalysts are selected from allyl(cyclopentadienyl)palladium(II), bis[(trimethylsilyl)methyl](1,5-cyclooctadiene)palladium(II), allylpalladium chloride dimer, ammonium tetrachloropalladate(II), bis[1,2-bis(diphenylphosphino)ethane]palladium(0), bis(dibenzylideneacetone)palladium(0), trans-bis(dicyclohexylamine)bis(acetato)-palladium(II), bis(2-methylallyl)palladium chloride dimer, bis(tri-t-butylphosphine)-palladium(0), bis(tricyclohexylphosphine)palladium(0), bis(tri-o-tolylphosphine)-palladium(0), chloromethyl(1,5-cyclooctadiene)palladium(II), diacetato[1,3-bis(diphenyl-phosphino)propane]palladium(II), diacetatobis(triphenylphosphine)palladium(II), diacetato(1,10-phenanthroline)palladium(II), di-p-bromobis(tri-t-butylphosphino)-dipalladium(I), trans-dibromobis(triphenylphosphine)palladium(II), dibromo(1,5-cyclo-octadiene)palladium(II), dichlorobis(benzonitrile)palladium(II), dichlorobis(di-t-butyl-phenylphosphino)palladium(II), di-p-chlorobis{2-[(dimethylamino)methyl]phenyl}di-palladium, trans-dichlorobis(tricyclohexylphosphine)palladium(II), trans-dichlorobis(tri-phenylphosphine)palladium(II), dichloro(1,5-cyclooctadiene)palladium(II), dichloro(nor-bornadiene)palladium(II), cis-dichloro(N, N,N′,N′-tetramethylethylenedi-amine)palladium(II), cis-dimethyl (N, N, N′,N′-tetramethylethylenediamine)palladium(II), (1-methylallyl)palladium chloride dimer, palladium(II) acetate, palladium(II) acetylacetonate, palladium(II) benzoate, palladium(II) bromide, palladium(II) chloride, palladium(II) hexafluoroacetylacetonate, palladium(II) iodide, palladium(II) sulfate, palladium(II) trifluoroacetate, palladium(II) trimethylacetate, tetrakis(triphenyl-phosphine)palladium(0), and tris(dibenzylideneacetone)dipalladium(0).

Suitable platinum pre-catalysts are selected from ammonium tetrachloroplatinate(II), bis(tri-t-butylphosphine)platinum (0), bis(ethylenediamine)platinum(II) chloride, dibromo(1,5-cyclooctadiene)platinum(II), dichlorobis(benzonitrile)platinum(II), cis-dichlorobis(diethylsulfide)platinum(II), cis-dichlorobis(pyridine)platinum(II), cis-dichlorobis(triethylphosphine)platinum(II), dichloro(1,5-cyclooctadiene)platinum(II), cis-dichlorodiammine platinum(II), di-μ-chloro-dichlorobis(ethylene)diplatinum(II), dichloro(dicyclopentadienyl)platinum(II), di-μ-iodobis(ethylenediamine)diplatinum(II) nitrate, diiodo(1,5-cyclooctadiene)platinum(II), dimethyl(1,5-cyclooctadiene)platinum(II), platinum(II) acetylacetonate, platinum(II) acetylacetonate, platinum(II) bromide, platinum(II) chloride, platinum(II) iodide, potassium bis(oxalato)platinate(II) dihydrate, tetrakis(triphenylphosphine)platinum(0), and tris(dibenzylideneacetone)diplatinum(0).

Suitable manganese pre-catalysts are selected from MnCl₂, MnCl₂·4 H₂O, MnBr₂, MnBr₂·4 H₂O, MnBr₂·2 THF, Manganocene, [Mn(Cylopentadienyl)(CO)₃], [Mn(Methylcylopentadienyl)(CO)₃], [Mn(Pentamethylcylopentadienyl)(CO)₃] MnOAc₂, MnOAc₂·4 H₂O, MnOAc₃·2 H₂O, Mn(II)acetylacetonate, Mn(III)acetylacetonate, Mn₂(CO)₁₀, Mn(NO₃)₂, [Mn(Br)(CO)₅], and Mn(ClO₄)₂·6 H₂O.

The abovementioned hydrogenation catalyst, which comprises the polydentate ligand conforming to general formula (I), may be used in the hydrogenation reaction without the need of additional bases. However, usually, higher activities are obtained by combining catalytic amounts of a base with the hydrogenation catalyst.

In one embodiment, the hydrogenation reaction is carried out in the presence of a base, preferably an alkali metal or alkaline earth metal carbonate, an alkali metal or alkaline earth metal hydroxide or an alkali metal or alkaline earth metal alcoholate. Preferably, the base is an alkali metal alcoholate such as potassium tert-butoxide.

Generally, the base is present in the hydrogenation reaction in the range of the amount of hydrogenation catalyst used. Suitably, the base is present in an amount of 1 to 50 equivalents, preferably 1 to 10 equivalents, more preferably 1 to 4 equivalents, based on the amount of hydrogenation catalyst.

The inventive process for hydrogenating spent polyurethanes may be carried out in customary devices and/or reactors known to the person skilled in the art for liquid-gas reactions in which the hydrogenation catalyst is present in the liquid phase. For the inventive process, it is in principle possible to use any reactor which is fundamentally suitable for gas-liquid reactions at the stated temperatures and the stated pressures. For suitable standard reactors for gas-liquid and for liquid-liquid reaction systems, see e.g.: Reactor Types and Their Industrial Applications and Reactors for gas-liquid reactions, in Ullmann's Encyclopedia of Industrial Chemistry, 2005, Wiley-VCH Verlag GmbH & Co. KGaA, chapter 3.3. Suitable examples include, e.g., stirred tank reactors, tubular reactors or bubble column reactors. The supply of polyurethane, hydrogenation catalyst, solvent and base may take place simultaneously or separately from one another. The reaction may be carried out discontinuously in batch mode or continuously, semi-continuously with recycle or without recycle. The average residence time in the reaction space may be varied in a wide range, preferably in the range from 15 minutes to 100 h, more preferably in the range from 1 to 50 h.

In particular, the invention involves spent polyurethanes as starting materials. In this context, the term “spent polyurethane” denotes an item produced from polyurethane at a time when it has already been used for the purpose for which it was manufactured.

Generally, polyurethanes are produced by a reaction between a polyisocyanate component and a polyol component. Further materials such as catalysts, chain extenders or chain termination reagents may be added in the production process of the polymers.

The properties of a polyurethane are influenced by the types of polyisocyanate and polyol components used. For example, the starting materials may influence the crosslinking of the polymers meaning that the polymer consists of a three-dimensional network. Long, flexible segments, contributed by the polyol, result in soft, elastic polymers. High amounts of crosslinking yield more rigid polymers, whereas long chains and low crosslinking effects a polymer that is very stretchy. Hard polymers are obtained from short chains with many crosslinks and long chains and intermediate crosslinking give polymers useful for making foams.

Industrially and consequently in large quantities, especially toluenediisocyanate (TDI) and methylene diphenyl diisocyanate (MDI) or its polymeric forms are used as polyisocyanate components. In smaller quantities, 1,6-hexanediisocycante, isophoronediisocyanate and 1,5-naphthyldiisocyante are used as polyisocyanate components. Common polyols used in huge quantities are, e.g., polyester polyols, low molecular weight polyols such as ethylene glycol or propylene glycol, or high molecular weight polyether polyols based on glycerol, ethylene glycol, polypropylene glycol and polytetramethylene glycol.

The present method enables re-utilization of both starting material components. The components are either recovered directly (polyols) or obtained as valuable synthesis building blocks such as polyamines which may readily be converted to polyisocyanates.

In one embodiment, the spent polyurethanes are selected from aromatic isocyanate-based polyurethanes, such as toluenediisocyanate-based polyurethanes, methylene diphenyl diisocyanate-based polyurethanes, and 1,5-naphthyldiisocyante-based polyurethanes, preferably methylene diphenyl diisocyanate-based polyurethanes, and 1,5-naphthyldiisocyante-based polyurethanes.

Aromatic isocyanates are compounds wherein the isocyanate functional group is directly bound to the aromatic core. In comparison, a compound such as p-xylylene diisocyanate is not considered an aromatic isocyanate because the isocyanate functional groups are bound to a methylene spacer and, hence, not directly to the aromatic core.

Toluenediisocyanate (TDI)-based polyurethanes are technical polymers and produced in a large scale (see: Polyurethanes, in Ullmann's Encyclopedia of Industrial Chemistry, 2012, DOI: 10.1002/14356007.a21_665.pub2). Generally, they are produced by a reaction of 2,4-toluenediisocyanate and 2,6-toluenediisocyanate with polyols and conform to the following general formula:

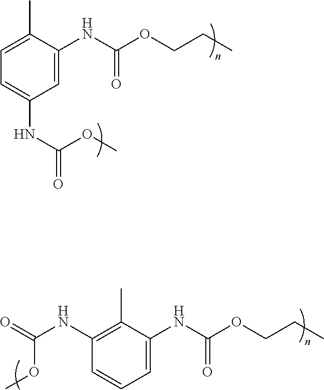

The process yields a polyamine comprising an amino group attached to the carbon atom to which in the initial polyisocyanate a isocyanate group was bound, e.g., methylene diphenyl diamines and toluenediamines (1,2-toluenediamine or 1,4-toluenediamine) or 1,5-naphthyldiamine. The commonly used polyols as described above can be re-isolated. Thus, the process further yields, e.g., polyester polyols, low molecular weight polyols such as ethylene glycol or propylene glycol, or high molecular weight polyether polyols based on glycerol, ethylene glycol, polypropylene glycol and polytetramethylene glycol.

The spent polyurethanes used in the present invention are obtained from items produced from polyurethane at a time after use for the purpose for which they were manufactured. Before subjecting to hydrogenation, the items may be subjected to mechanical comminution. That is, further sorting and bringing the items into appropriate sizes, e.g., by shredding, sieving or separation by rates of density, i.e. by air, a liquid or magnetically. Optionally, these fragments may then undergo processes to eliminate impurities, e.g. paper labels.

Generally, the solvent is employed in an amount sufficient to swell or partially dissolve the polyurethane. As the hydrogenation reaction progresses, the polyurethane gradually dissolves in the reaction solution. Suitably, the ratio of solvent and spent polyurethanes is in the range of 0.1 to 100 L solvent per 1 kg polyurethane, preferably 1 to 20 L solvent per 1 kg.

The work-up of the reaction mixture obtained after hydrogenation, in particular the isolation of methylene diphenyl diamines, toluenediamines (1,2-toluenediamine or 1,4-toluenediamine) or 1,5-naphthyldiamine and polyols can be realized case dependent, for example by filtration, aqueous extractive work-up or distillation under reduced pressure. Preferably, the work up comprises several steps. For example, volatile compounds such as amines can be separated by distillation. Polyol compounds are preferably recovered by extraction of the reaction solution with a suitable extractant. Thereby, the hydrogenation catalyst remains in the distillation-residue to allow recycling. The catalyst, once separated from the product, can be returned to the reactor for re-use. Alternatively, the catalyst solution can be diluted with a solvent and re-used. It is understood that the separation process described above can be combined with any of the various embodiments of the inventive process described herein.

### EXAMPLES

The present invention can be further explained and illustrated on the basis of the following examples. However, it will be understood that these examples are included merely for purposes of illustration and are not intended to limit the scope of the invention in any way.

All chemicals and solvents were purchased from Sigma-Aldrich or ABCR and used without further purification, unless otherwise specified. ¹H—, ¹³C— and ³¹P NMR spectra were recorded on Bruker Avance 200 or 400 MHz spectrometer and were referenced to the residual proton (¹H) or carbon (¹³C) resonance peaks of the solvent. Chemical shifts (δ) are reported in ppm. ³¹P NMR spectra were referred to an external standard (ample of D₃PO₄).

Hydrogenation catalysts P and Q were prepared according literature protocols: E. Balaraman, J. Am. Chem. Soc. 2010, 132, 16756-16758 and D. Srimani, Adv. Synth. Catal. 2013, 355, 2525-2530.

### Reference Example 1: Synthesis of Hydrogenation Catalyst H

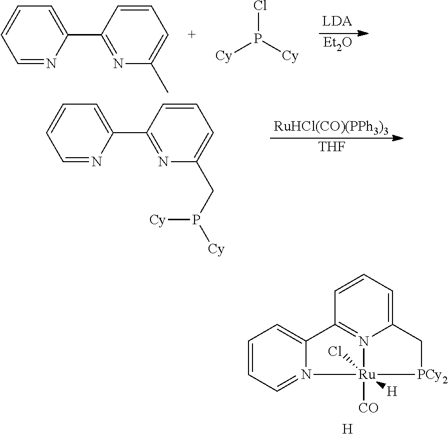

First step: In a 50 mL Schlenk tube, 6-methyl-2,2′-bipyridine (511 mg, 3.00 mmol) was dissolved in 15 mL Et₂O, cooled to 0° C. and LDA (3.50 mL, 1 M in THF/hexanes) was added dropwise. After stirring at 0° C. for 1 h, the system was cooled to −80° C. by ⁱPrOH/liquid N₂ and CIPCy₂ (815 g, 3.50 mmol) in 5 mL Et₂O was added slowly. The cooling bath was removed after 1 h and the mixture was recovered to r.t. gradually and stirred overnight. The reaction mixture was quenched by adding 10 mL of degassed water to the yellow slurry. The organic phase was separated and the aqueous phase was extracted with ether (2×5 mL). The combined organic phase was dried over Na₂SO₄, filtered and the solvent was removed to give the crude ligand as a sticky orange oil. 52% purity based on ³¹P NMR. It was used directly for the next step without further purification.

Second step: The ligand obtained in the first step was dissolved in 20 mL THF. RuHCl(CO)(PPh₃)₃ (952 mg, 1.00 mmol) was added, the mixture was stirred at 70° C. for 5 hours and then cooled to r.t. The solvent was reduced to ca. 10 mL under vacuum and 20 mL of Et₂O were added to the remaining red-orange dispersion. The solution was removed via cannula and the solid was washed with Et₂O (2×10 mL) and dried under vacuum to give 465.2 mg of the orange product (87% yield based on Ru). ³¹P {¹H} NMR (122 MHz, CD₂Cl₂) δ 83.68.

¹H NMR (301 MHz, CD₂Cl₂) δ 9.22-9.13 (m, 1H), 8.07-7.97 (m, 1H), 7.93 (d, J=8.0 Hz, 1H), 7.86 (td, J=8.0, 1.6 Hz, 1H), 7.82 (td, J=8.0, 0.9 Hz, 1H), 7.49 (d, J=7.7 Hz, 1H), 7.45-7.39 (m, 1H), 3.82-3.56 (m, 2H), 2.46-2.27 (m, 2H), 2.08-0.99 (m, 20H), -14.83 (d, J=23.6 Hz, 1H).

¹³C {1H} NMR (126 MHz, CD₂Cl₂) δ 207.71 (d, J=14.9 Hz), 161.70 (d, J=5.1 Hz), 156.38, 154.78 (d, J=2.7 Hz), 153.51 (d, J=1.7 Hz), 137.30, 136.51, 126.42 (d, J=1.9 Hz), 123.13 (d, J=9.6 Hz), 122.76 (d, J=1.6 Hz), 119.73, 40.59 (d, J=22.2 Hz), 38.59 (d, J=23.4 Hz), 35.76 (d, J=28.9 Hz), 31.01 (d, J=2.9 Hz), 29.60 (d, J=4.2 Hz), 28.61 (d, J=4.5 Hz), 28.20 (d, J=13.6 Hz), 27.73, 27.56 (d, J=9.2 Hz), 26.82 (d, J=4.4 Hz), 26.74 (d, J=3.5 Hz), 26.71 (d, J=2.0 Hz), 26.35 (d, J=1.5 Hz). HRMS (ESI): m/z calcd. for C₂₄H₃₂N₂OPRu [M-Cl]⁺: 497.1296, found: 497.1291.

### Preparation of Reference Material 1: Preparation of a Polyurethane Sample

2,4-Toluenediisocyanate (3.48 g, 20.0 mmol) was dissolved in 40 mL DMF. Ethylene glycol (1.24 g, 20.0 mmol) was added dropwise while stirring. The mixture was stirred at r.t. for 2 h and then heated to 60° C. for 2 h. The solution was poured into 100 mL of water to give solid precipitates. The solvent was filtered off and the solid was washed with ether and dried in a 60° C. oven overnight to give the product as a white solid (4.11 g, MW=4476 g/mol).

### Preparation of Reference Material 2: Preparation of a Polyurethane Sample

2,4-Toluenediisocyanate (3.48 g, 20 mmol) was dissolved in 20 mL of DMF and 1,6-hexandiol (2.36 g, 20 mmol) in 20 mL DMF was added slowly. After the addition, the system was left stirring at room temperature for 2 h and heated to 60° C. for 2 h. The resulting solution was poured into 100 mL of water to give precipitates. The solid residue was washed with water, Et₂O and dried in a 60° C. oven yielding a white solid (5.21 g, MW=2800 g/mol).

### Preparation of Reference Material 3: Preparation of a Polyurethane Sample

Methylenediphenyl isocyanate (5.00 g, 20 mmol) was dissolved in 20 mL DMF and 1,6-hexandiol (2.36 g, 20 mmol) in 20 mL DMF was added slowly. After the addition, the system was left stirring at room temperature for 2 h and heated to 60° C. for 2 h. The resulting solution was poured into 100 mL of water to give precipitates. The solid residue was washed with water, Et₂O and dried in a 60° C. oven yielding a white solid (6.80 g, MW=3290 g/mol).

### Example 1: Hydrogenation of Polyurethane Reference Material 2

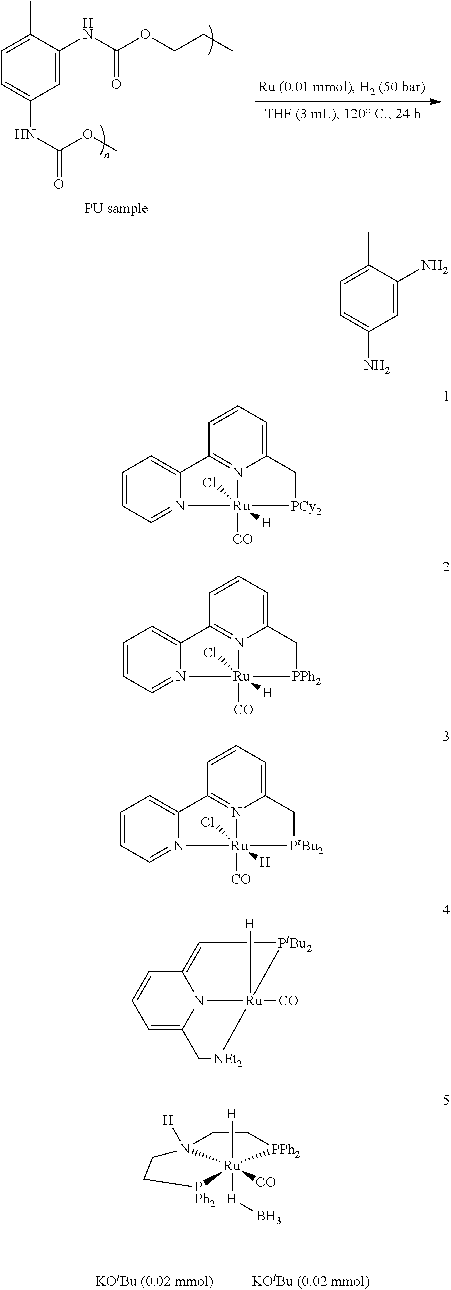

Under argon, ruthenium catalyst (see table 1 below, 0.01 mmol), KOBu (0.02 mmol, if applicable), the polyurethane reference material 2 (0.12 g) and 3 mL THF were added to a 10 mL microwave crimp-cap vial, equipped with a magnetic PTFE stirring bar. The vial was closed with the crimp-cap septum with a needle plug through and placed into a HEL CAT-7 autoclave. The autoclave was charged with 50 bar of H₂ outside the glovebox, heated to 120° C. and stirred for 24 h. Afterwards, the autoclave was cooled to r.t. and pressure was released carefully, mesitylene was added as internal standard to each glass vial and the product was determined by GC analysis.

TABLE 1

| hydrogenation cat. | 1 | 2 | 3 | 4 | 5 |
|---|---|---|---|---|---|
| diamine [mmol] | 0.33 | 0.34 | 0.24 | 0.34 | 0.31 |
| yield [%] | 65 | 67 | 47 | 67 | 61 |
| turn-over-number^{[a]} | 33 | 34 | 24 | 34 | 31 |

^{[a]}moles of diamine per mole of catalyst.

### Example 2: Hydrogenation of Polyurethane Reference Material 2

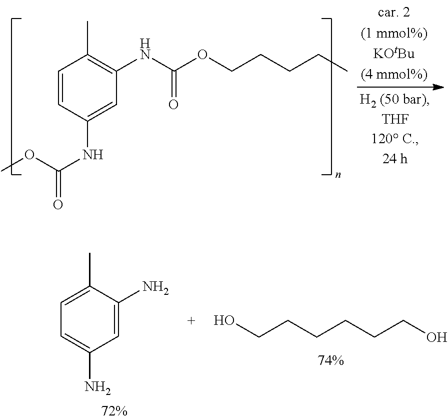

Under argon, a 60 mL Premex autoclave equipped with a Teflon insert was charged with polyurethane reference material 2 (0.29 g, 1 mmol calculated as the repeating unit of the polyurethane). The ruthenium complex as shown above and KOBu together with 5 mL of THF were added. The autoclave was closed, charged with 50 bar of H₂ outside the glovebox and put into a preheated aluminum block (120° C.). After 20 h, the reaction was stopped by taking the autoclave out of the heating block and cooling to r.t. in water. The internal pressure was carefully released. Afterwards, mesitylene was added as internal standard to each glass vial and the product was determined by GC analysis. According to the yield of diaminotoluene, the turn-over-number is 72.

### Example 3: Hydrogenation of Polyurethane Reference Material 3

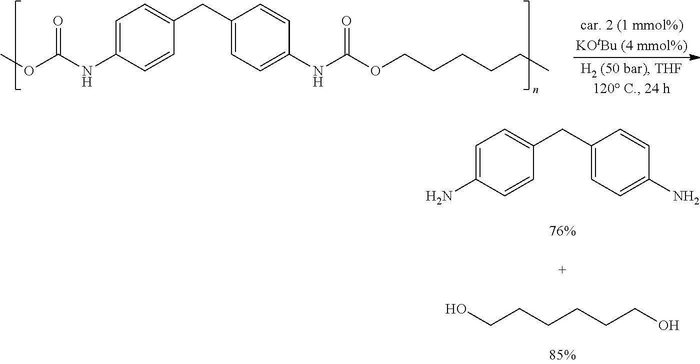

Under argon, a 60 mL Premex autoclave equipped with a Teflon insert was charged with polyurethane reference material 3 (0.37 g, 1 mmol calculated as the repeating unit of the polyurethane). The ruthenium complex as shown above and KOBu together with 5 mL of THF were added. The autoclave was closed, charged with 50 bar of H₂ outside the glovebox and put into a preheated aluminum block (120° C.). After 20 h, the reaction was stopped by taking the autoclave out of the heating block and cooling to r.t. in water. The internal pressure was carefully released. Afterwards, mesitylene was added as internal standard to each glass vial and the product was determined by GC analysis. According to the yield of the diamine, the turn-over-number is 76.

### Example 4: PU Foam Hydrogenation

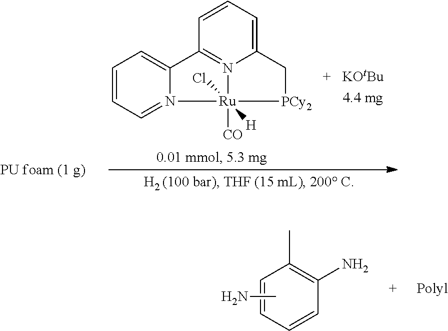

Under argon, a 60 mL Premex autoclave equipped with a Teflon insert was charged with a toluenediisocyanate-based polyurethane and the polyol (Lupranol 2074; trifunctional polyetherol-based on glycerol and propylene oxide; MW 3500 g/mol). The ruthenium complex and KOBu together with 15 mL of THF were added. The autoclave was closed, charged with 100 bar of H₂ outside the glovebox and put into a preheated aluminum block (200° C.). After 20 h, the reaction was stopped by taking the autoclave out of the heating block and cooling to r.t. in water. The internal pressure was carefully released. The mixture was transferred to a 50 mL round bottom flash and the solvent was removed in vacuum. The residue was dissolved in 5 mL CDCl₃, mesitylene was added as internal standard, the diamine product was quantified using ¹H NMR (1.87 mmol) and was further isolated via column chromatography (200 mg, 1.64 mmol) as a mixture of 2,4-toluenediisocyanate and 2,6-toluenediisocyanate. According to the yield of diaminotoluene, the turn-over-number is 164. According GPC-analysis of the reaction mixture, the polyol was obtained with an average molecular mass of 3500 g/mol, showing that the polyol can be obtained without degradation.

### Example 5: Large Scale PU Foam Hydrogenation

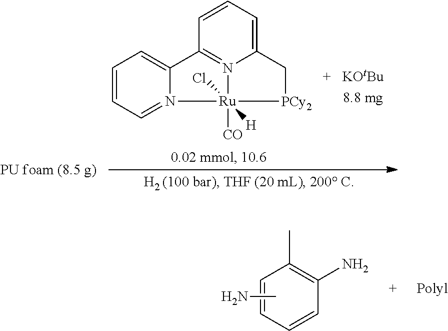

Under argon, a 60 mL Premex autoclave equipped with a Teflon insert was charged with a toluenediisocyanate-based polyurethane and the polyol (Lupranol 2074; trifunctional polyetherol-based on glycerol and propylene oxide; MW 3500 g/mol). The ruthenium complex and KOBu together with 50 mL of THF were added. The autoclave was closed, charged with 100 bar of H₂ outside the glovebox and put into a preheated aluminum block (200° C.). After 30 h, the reaction was stopped by taking the autoclave out of the heating block and cooling to r.t. in water. The internal pressure was carefully released. The resultant solution was filtered via syringe filter and the solvent was removed on a rotavap. Conversion (96%) was estimated by the weight of remaining solid after filtration and diaminotoluene (1.63 g) and Lupranol® 2074 were separated via column chromatography (4.84 g). According to the yield of diaminotoluene, the turn-over-number is 667. According GPC-analysis of the reaction mixture, the polyol was obtained with an average molecular mass of 3500 g/mol, showing that the polyol can be obtained without degradation.

### Example 6: Hydrogenation of a PU Based Commercial Product (Yellow Kitchen Sponge)

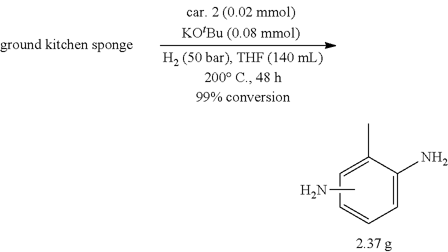

The yellow kitchen sponge was cut off from a household scouring pad and was ground before hydrogenation. 10.0 g of ground kitchen sponge powder was subjected to hydrogenation. The reaction was conducted in a 200 mL Premex autoclave. After the reaction was finished, the solution was filtered via syringe filter and the solvent was removed on a rotavap. Conversion was estimated by the weight of remaining solid after filtration and diaminotoluene was isolated by column chromatography. According to the yield of diaminotoluene, the turn-over-number is 970.

### Comparative Example: Runs 1 and 2 Using Heterogeneous Catalysts

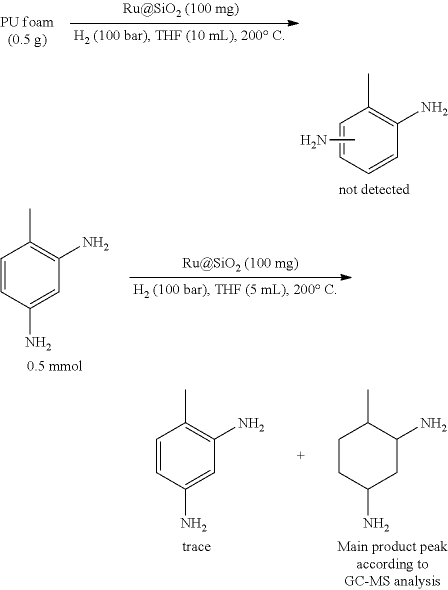

Runs 1 and 2 of the comparative example were carried out in the same way as example 4 (PU foam hydrogenation) except that a heterogeneous SiO₂ supported ruthenium catalyst was used instead of the homogeneous hydrogenation catalyst. Also, the solvent volumes were adapted as shown above.

The comparative experiments show that the use of a heterogeneous ruthenium-catalyst under the otherwise inventive conditions does not yield toluenediamines. Instead, the aromatic ring is hydrogenated and the undesired saturated monomeric diamine is the main product.

Hydrogenation catalyst L, or alternatively named Mn-8, was prepared according to the following literature protocol: K. Das, A. Kumar, Y. Ben-David, M. A. Iron, D. Milstein, J. Am. Chem. Soc. 2019, 141, 12962-12966.

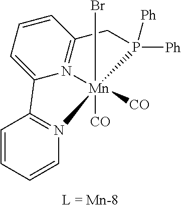

General protocol for the hydrogenation of polyurethanes with Manganese catalysts: Inside an Ar glove box, a Premex autoclave (30, 60, 100 or 200 mL) was equipped with a Teflon insert and a magnetic stirring bar and was charged with the polymer sample, Mn catalyst, KOtBu and solvent. The sealed autoclave was taken out of the glove box, charged with Hz, and transferred to a preheated aluminum block. The reaction was stirred for the indicated time and cooled to room temperature in an ice bath. Afterwards, the hydrogen pressure was carefully released, mesitylene was added as an internal standard and the crude reaction mixture was submitted for GC analysis. In case of the larger scale hydrogenations shown in schemes 1 and 2, the products were isolated and purified by column chromatography.

### Example 7

Polyurethane reference material 2 was used as the polyurethane.

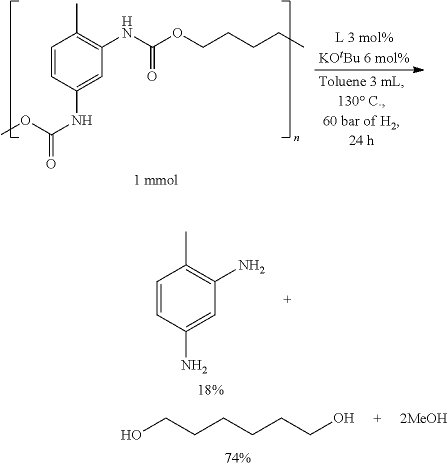

### Example 8

Polyurethane reference material 2 was used as the polyurethane.

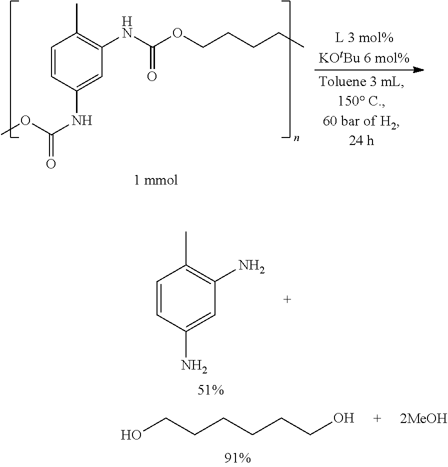

### Example 9

Polyurethane reference material 2 was used as the polyurethane.

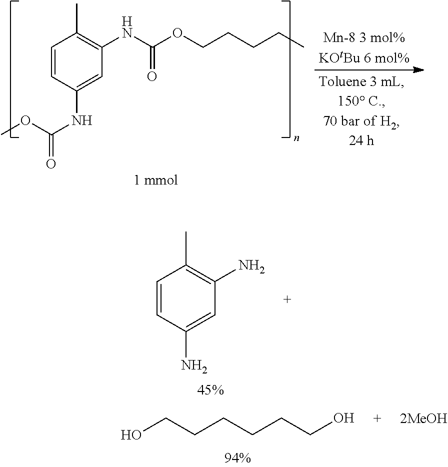

### Example 10

Polyurethane reference material 2 was used as the polyurethane.

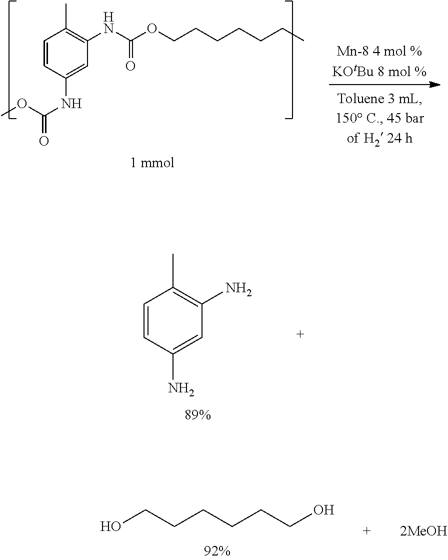

### Example 11

Polyurethane reference material 2 was used as the polyurethane.

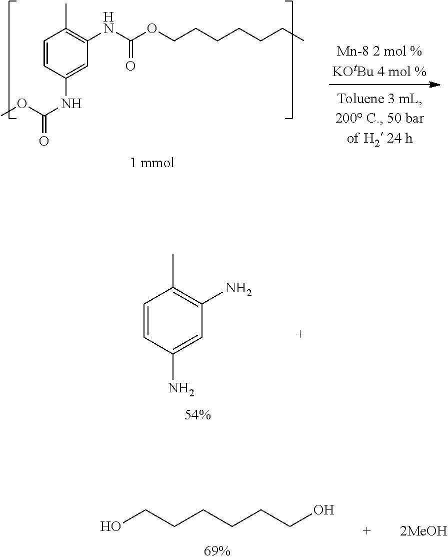

### Example 12: Solvent Screening

Polyurethane reference material 2 was used as the polyurethane.

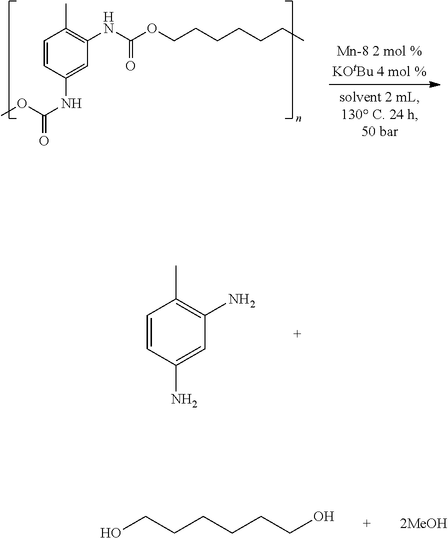

| # | solvent | amine (GC yield) [%] | diol (GC yield) [%] |
|---|---|---|---|
| 1 | toluene | 33 | 71 |
| 2 | ethanol | 0 | 86 |
| 3 | isopropanol | 9 | 70 |
| 4 | dioxane | 16 | 57 |
| 5 | tetrahydrofuran | 10 | 68 |

### Example 13

In this example, an additive free PU foam was used. It is based on toluenediisocyanate and a trifunctional polyetherol based on glycerol and propylene oxide having a molecular weight of 3500 g/mol.

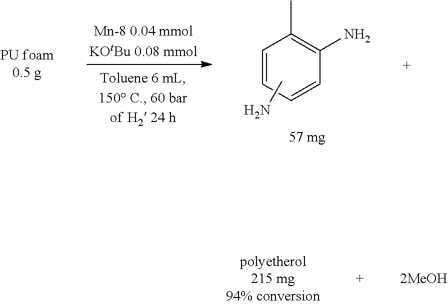

### Example 14

The PU foam of example 13 was used.

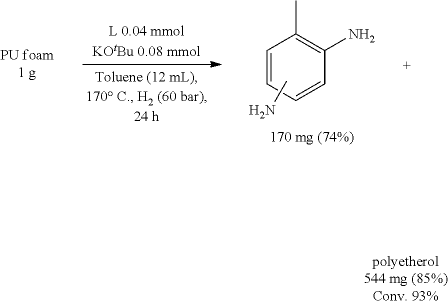

### Example 15

The PU foam of example 13 was used.

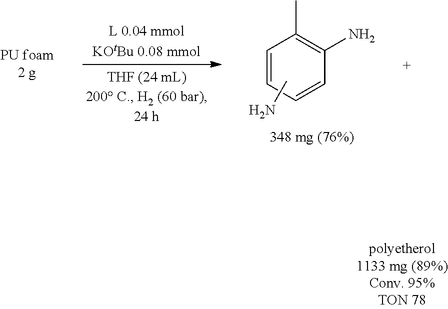

### Example 16

Polyurethane reference material 3 was used as the polyurethane.

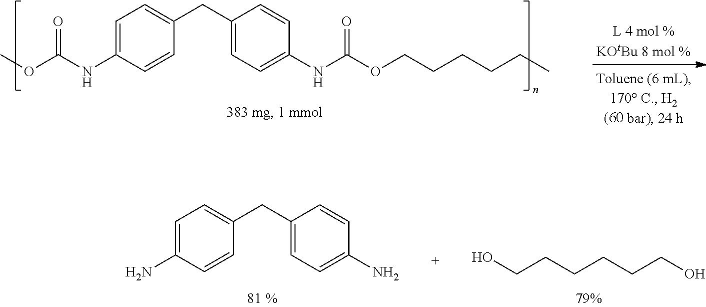

### Example 17

A commercial polyurethane kitchen sponge was used. The material was a toluenediisocyanate-based polyurethane with an unspecified polyetherol.

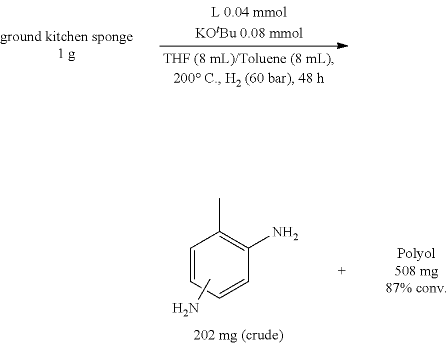

### Example 18

A polyurethane soft foam from an end-of-life office chair was used. The material was a methylenediphenyl isocyanate-based polyurethane with an unspecified polyetherol.

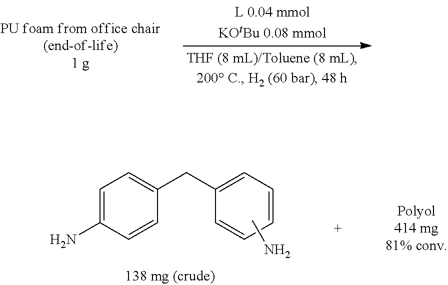

### Example 19

An end-of-life black-colored polyurethane soft foam packaging material was used. The material was a toluenediisocyanate-based polyurethane with an unspecified polyetherol.

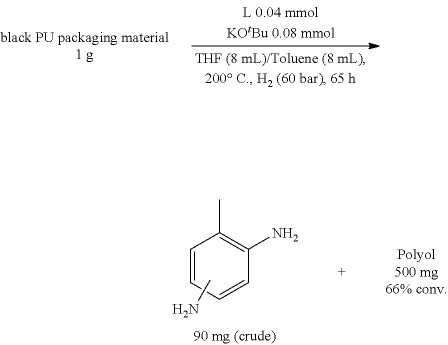

### Example 20

A rigid polyurethane foam was used. The material was a methylenediphenyl isocyanate-based polyurethane with an unspecified polyetherol.

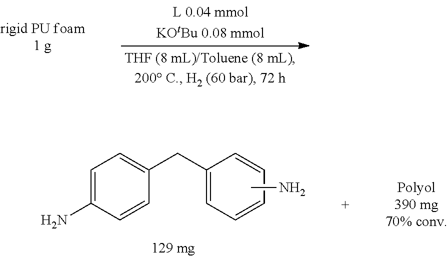

### Example 21

An end-of-life polyurethane soft foam from mattresses (mattress 1) was used. The material was a toluenediisocyanate-based polyurethane with an unspecified polyetherol.

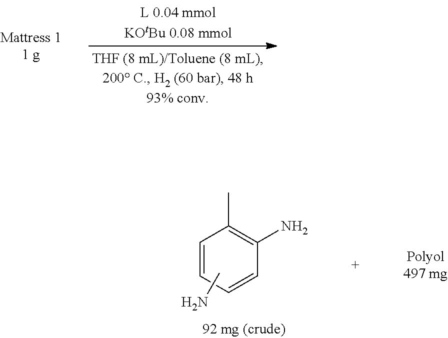

### Example 22

An end-of-life polyurethane soft foam from mattresses (mattress 2) was used. The material was a toluenediisocyanate-based polyurethane with an unspecified polyetherol.

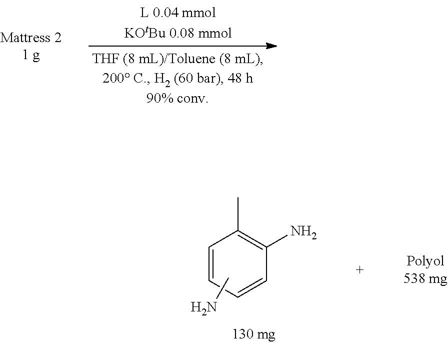

### Example 23

An end of life polyurethane soft foam from mattresses (mattress 3) was used. The material was a toluenediisocyanate-based polyurethane with an unspecified polyetherol.

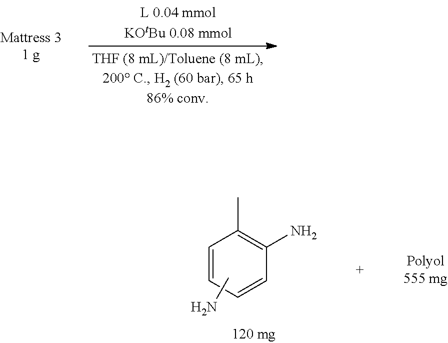

1. A value chain return process for spent polyurethanes, comprising hydrogenating the spent polyurethanes in a hydrogen atmosphere in the presence of at least one homogeneous transition metal catalyst complex, wherein the transition metal is selected from metals of groups 7, 8, 9 and 10 of the periodic table of elements according to IUPAC, to obtain a polyamine and a polyol, wherein the hydrogenation reaction is carried out at a reaction temperature of at least 120° C. in a non-reducible solvent having a dipole moment of 10·10⁻³⁰ C·m or less.

2. The process according to claim 1, wherein the non-reducible solvent comprises at least one electron pair donor.

3. The process according to claim 1, wherein the non-reducible solvent is selected from ethers, alcohols and amines.

4. The process according to claim 1, wherein the non-reducible solvent is selected from aromatic solvents.

5. The process according to claim 4, wherein the aromatic solvent is selected from benzene, toluene, xylene, mesitylene, and anisole.

6. The process according to claim 1, wherein the hydrogenation reaction is carried out in the essential absence of DMSO.

7. The process according to claim 1, wherein the reaction temperature is from 150 to 220° C.

8. The process according to claim 1, wherein the spent polyurethanes are selected from aromatic isocyanate-based polyurethanes.

9. The process according to claim 1, wherein the homogeneous transition metal catalyst complex comprises a transition metal selected from manganese, rhenium, ruthenium, iridium, nickel, palladium or platinum.

10. The process according to claim 9, wherein the transition metal is manganese and the non-reducible solvent is an aromatic solvent.

11. The process according to claim 1, wherein the homogeneous transition metal catalyst complex comprises at least one polydentate ligand having at least one nitrogen atom and at least one phosphorous atom which are capable of coordinating to the transition metal.

12. The process according to claim 11, wherein the at least one polydentate ligand conforms to general formula (I) 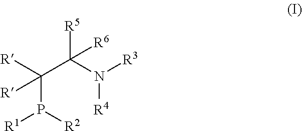
in which
each R′ is independently H or C₁-C₄-alkyl,
R¹ and R², independently of one another, are C₁-C₁₂-alkyl, cycloalkyl or aryl,
which alkyl is unsubstituted or carries 1, 2, 3, 4 or 5 identical or different substituents R⁷, and
which cycloalkyl and aryl are unsubstituted or carry 1, 2, 3, 4 or 5 identical or different substituents R⁸,
R³ and R⁴, independently of one another, are H or C₁-C₁₂-alkyl, which is unsubstituted or carries 1, 2, 3, 4 or 5 identical or different substituents selected from heterocycloalkyl, aryl, hetaryl, alkoxy, cycloalkoxy, heterocycloalkoxy, aryloxy, hetaryloxy, hydroxyl, NE¹E² and PR¹R²,
R⁵ is H or C₁-C₁₂-alkyl, which is unsubstituted or carries 1, 2, 3, 4 or 5 identical or different substituents R⁷,
R⁶ is H or C₁-C₄-alkyl,
or
R⁴ and R⁶ are absent and R³ and R⁵, together with the nitrogen atom to which R³ is bonded and the carbon atom to which R⁵ is bonded, form a 6-membered heteroaromatic ring,
which is unsubstituted or carries 1, 2, 3, 4 or 5 identical or different substituents which are selected from C₁-C₁₂-alkyl, cycloalkyl, aryl and hetaryl,
which alkyl is unsubstituted or carries 1, 2, 3, 4 or 5 identical or different substituents R⁷, and
which cycloalkyl, aryl and hetaryl are unsubstituted or carry an alkyl substituent which is unsubstituted or carries a substituent selected from alkoxy, cycloalkoxy,
heterocycloalkoxy, aryloxy, hetaryloxy, hydroxyl, NE¹E² and PR¹R²,
each R⁷ is independently cycloalkyl, heterocycloalkyl, aryl, hetaryl, alkoxy, cycloalkoxy, heterocycloalkoxy, aryloxy, hetaryloxy, hydroxyl or NE¹E²,
each R⁸ is independently C₁-C₄-alkyl, cycloalkyl, heterocycloalkyl, aryl, hetaryl, alkoxy, cycloalkoxy, heterocycloalkoxy, aryloxy, hetaryloxy, hydroxyl or NE¹E², and
E¹ and E², independently of one another and independently of each occurrence, are radicals selected from H, C₁-C₁₂-alkyl, cycloalkyl and aryl.

13. The process according to claim 12, wherein the at least one polydentate ligand conforms to general formula (II) 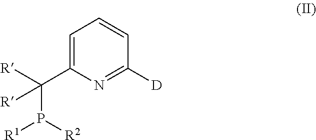
in which
D is H, C₁-C₁₂-alkyl, cycloalkyl, aryl or hetaryl,
which alkyl is unsubstituted or carries 1, 2, 3, 4 or 5 identical or different substituents R⁷, and
which cycloalkyl, aryl or hetaryl are unsubstituted or carry an alkyl substituent which is unsubstituted or carries a substituent selected from alkoxy, cycloalkoxy,
heterocycloalkoxy, aryloxy, hetaryloxy, hydroxyl, NE¹E² and PR¹R², preferably NE¹E² and PR¹R².

14. The process according to claim 1, wherein the at least one polydentate ligand is selected from compounds A to L, wherein Et is ethyl, iPr is isopropyl, tBu is tert-butyl, Cy is cyclohexyl, Ph is phenyl:

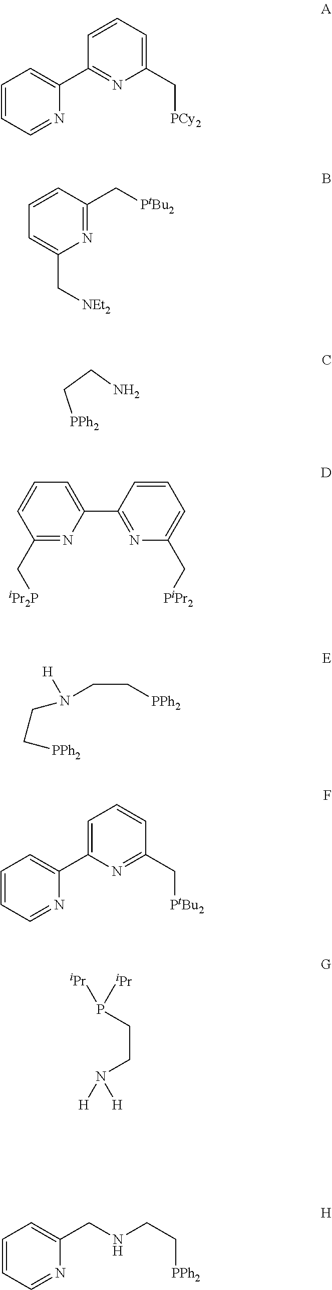

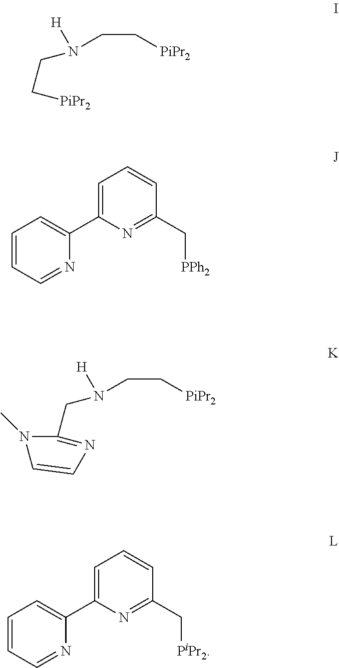

15. The process according to claim 1, wherein the hydrogenation reaction is carried out at a pressure of 30 to 500 bar absolute.

16. The process according to claim 1, wherein the hydrogenation reaction is carried out in the presence of a base.
